(19) United States
(12) Patent Application Publication
(10) Pub. No.: US 2018/0135791 A1
(43) Pub. Date: May 17, 2018

(54) Indicating Crimp Ring

(71) Applicant: Zurn Industries, LLC, Milwaukee, WI (US)

(72) Inventor: Jacob D. Twaroski, Erie, PA (US)

(21) Appl. No.: 15/812,865

(22) Filed: Nov. 14, 2017

Related U.S. Application Data
(60) Provisional application No. 62/422,468, filed on Nov. 15, 2016.

(51) Int. Cl. F16L 55/17; A01G 25/02

(52) U.S. Cl. CPC F16L 55/1705; F16L 2201/10; A01G 25/026

(57) ABSTRACT

A crimping ring is used for securing a fitting within a tube. The crimping ring comprises a metallic ring and an indicator. The metallic ring has a radially inward surface and a radially outward surface. The indicator is applied to at least a portion of the radially outward surface of the metallic ring and visually indicates a dimensional state of the crimping ring to a user.

### CROSS-REFERENCE TO RELATED APPLICATION

The present application claims priority to U.S. Provisional Patent Application No. 62/422,468, filed Nov. 15, 2016, entitled “Indicating Crimp Ring”, which is hereby incorporated by reference in its entirety for all purposes.

### STATEMENT OF FEDERALLY SPONSORED RESEARCH OR DEVELOPMENT

Not applicable.

### BACKGROUND

This disclosure relates, in general, to improvements in crimping rings for making leak-free tube connections for water piping. More particularly, this disclosure relates to crimping rings that can be used to form seals in a number of different piping and tubing applications and to crimping rings that may be suitable for use with piping made from polyolefin, polyethylene, cross-linked polyethylene, PEX-a, PEX-b, PEX-c, PERT, or any other similar material.

Cross-linked polyethylene (PEX) has become increasingly popular in a number of applications, including heating, cooling, gas, and water transport systems. It is now used frequently in plumbing applications in residential, commercial, and industrial applications.

PEX tubing allows an easy, safe, and fast installation for workers. PEX tubing does not require welding, soldering, chemical application, or heating to form an adequate seal between the tubing and a fitting. Instead, a crimping ring and a crimping tool can be used to quickly create a leak-proof seal between a fitting and the PEX tubing.

The crimping rings that are used to create seals are typically formed of a copper material. To create a seal, a piece of PEX tubing is first cut to a desired length. A crimping ring is then slid over the outer diameter of the tubing. A fitting is then partially inserted into the inner diameter of the tubing, where the fitting may be positioned by a stop edge in the fitting coming into contact with a surface of the PEX tubing. The crimping ring may then be positioned radially outward from the fitting and the tubing. Using a crimping tool, the crimping ring is then reduced in size circumferentially around the fitting and tubing, such that a leak-proof seal is formed between the PEX tubing and the fitting.

### SUMMARY

Current crimping rings do not visibly display whether or not they have been crimped. Accordingly, contractors must go and physically inspect each connection to ensure that a fitting has been crimped properly and is ready for use. The time spent rechecking current fitting seals to determine if they have been crimped or not is wasted time, which can add time and expense to the installation process.

Disclosed herein is an improved crimping ring for use in PEX tubing applications, as well as a method of producing and installing such a crimping ring.

According to one aspect, a crimping ring for securing a fitting within a tube is disclosed. The crimping ring comprises a metallic ring having a radially inward surface and a radially outward surface. Additionally, the crimping ring comprises an indicator applied to at least a portion of the radially outward surface of the metallic ring. The indicator visually indicates a dimensional state of the crimping ring.

In some forms, the dimensional state of the crimping ring may be one of crimped or not crimped.

In some forms, the metallic ring and the indicator may comprise different colors and/or the indicator may change colors to indicate a changed state of the crimping ring when a threshold pressure has been applied to the radially outward surface of the metallic ring. Additionally or alternatively, in some forms, at least a portion of the indicator may release from the radially outward surface of the metallic ring when a threshold pressure has been applied to the radially outward surface of the metallic ring to indicate a changed state of the crimping ring. In some forms, the indicator may comprise paint, may be a film adhesively applied to the radially outward surface of the metallic ring, or may comprise other materials.

According to another aspect, a method of securing a fitting within a tube is disclosed. The method includes placing a crimping ring over a portion of an outer surface of a tube. As described above, the crimping ring includes a metallic ring and an indicator, in which the metallic ring has a radially inward surface and a radially outward surface and the indicator is applied to at least a portion of the radially outward surface of the metallic ring. The indicator is configured to indicate a dimensional state of the crimping ring. The method further includes placing a fitting within a portion of an inner surface of the tube and crimping the crimping ring to form a seal between the fitting and the inner surface of the tube. The process of crimping the crimping ring causes the indicator to be altered.

In some forms, a color of the indicator may be altered when the crimping ring is crimped. For example, the indicator may comprise a color-changing plastic, a color-changing paint, a color-changing film, or other materials. In some forms, the altering of the indicator may include removing a portion of the indicator from the crimp ring. In such forms, the portion of the indicator removed may comprise paint, film, or other materials. The crimping process may be performed by a crimping tool.

According to another aspect, a method of manufacturing a crimping ring is disclosed. The method includes forming a metallic ring having a radially inward surface and a radially outward surface. The method further includes applying an indicator to a portion of the radially outward surface of the metallic ring, where the indicator visually indicates a dimensional state of the crimping ring.

In some forms, the dimensional state of the crimping ring may be one of crimped or not crimped.

In some forms, the indicator may be a polymeric material, a paint, or take any of the forms discussed above or herein.

In some forms, the metallic ring may include copper, although it will be appreciated that other metals might also be used, as well as alloys thereof.

These and still other advantages of the invention will be apparent from the detailed description and drawings. What follows is merely a description of some preferred embodiments of the present invention. To assess the full scope of the invention, the claims should be looked to, as these preferred embodiments are not intended to be the only embodiments within the scope of the claims.

### BRIEF DESCRIPTION OF THE FIGURES

FIG. 1 is a side view of a prior art PEX fitting formed using a crimp ring.

FIG. 2A is a side view of a PEX connection in a non-crimped state that incorporates a crimping ring according to an embodiment of the present disclosure.

FIG. 2B is a side view of the PEX connection of FIG. 2A in a crimped state.

FIG. 3 is a view of a crimping ring, such as the crimping ring used in FIGS. 2A-2B, looking down the central axis of the crimping ring.

FIG. 4 is a cross-sectional side view of the crimping ring of FIG. 3, taken along line 4-4.

FIG. 5 is a block diagram directed to a method of installing a fitting in a tubing system using a crimping ring, such as the crimping ring of FIGS. 2A, 2B, 3, and 4.

FIG. 6 is a block diagram directed to a method of manufacturing a crimping ring, such as the crimping ring of FIGS. 2A, 2B, 3, and 4.

Corresponding reference characters indicate corresponding parts throughout the several views. Although the drawings represent embodiments of the present disclosure, the drawings are not necessarily to scale and certain features may be exaggerated in order to better illustrate and explain the embodiments of the present disclosure.

### DETAILED DESCRIPTION

For the purposes of promoting an understanding of the principles of the present disclosure, reference will now be made to a number of illustrative embodiments shown in the attached drawings and specific language will be used to describe the same.

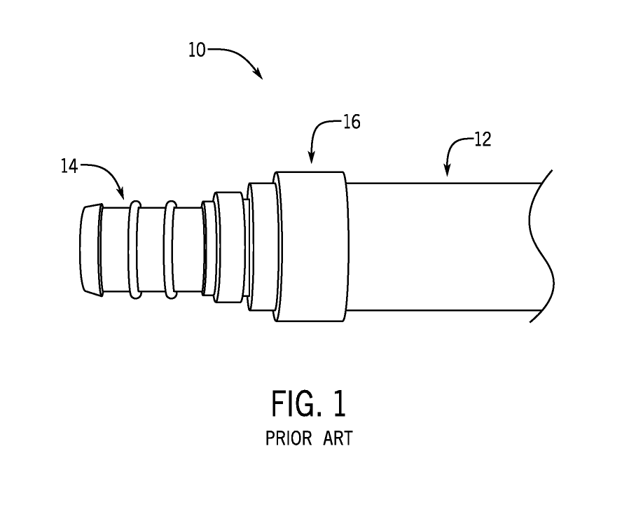

FIG. 1 shows a conventional PEX connection 10. This PEX connection 10 includes three main parts: a PEX tube 12 with a fluid passageway running therethrough, a fitting 14, and a crimping ring 16 which is typically made of a deformable material (typically, metallic and, most typically, copper).

The assembly of the conventional PEX connection 10 is relatively straightforward. First, one end of the fitting 14 is received into the fluid passageway of the tube 12 on one end of the tube 12. Next, with the tube 12 in place relative to the fitting 14, it is assured that the crimping ring 16 is disposed or positioned around the portion of the fitting 14 received in the tube 12. The crimping ring 16 is then crimped such that the end portion of the tube 12 is compressed by the crimping ring 16 against the end of the fitting 14 received therein. This compression forms a water-tight seal between the outer surface of the fitting 14 and the inner surface of the passageway of tube 12.

The crimping step may be performed by a crimping tool such as, for example, the PEX Combo Crimp Tool by Everhot Inc. Using such a tool, the crimping ring 16 is reduced in diameter evenly about the entire circumference of the crimping ring 16. As noted above, the reduction in size of the crimping ring 16 compresses the tube 12 around the fitting 14, such that a leak-free, water-tight seal is created between the components.

The deformation of the crimping ring 16 during crimping is ideally plastic in nature, as opposed to elastic. Preferably, the crimping ring 16 is permanently deformed in a manner that maintains sufficient force to maintain the water-tight seal between the tube 12 and the fitting 14, even under the applied water pressure during usage.

After crimping, the installer may check that the appropriate crimp has occurred by checking a dimension (for example, an outer diameter) of the crimped crimping ring 20 using, for example, a go/no-go gauge.

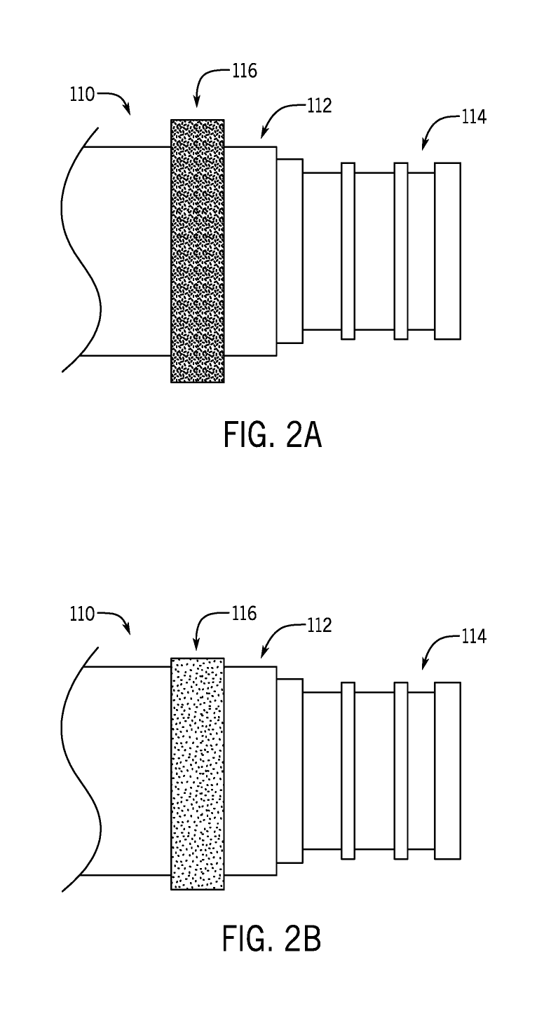

Turning now to FIG. 2A and 2B, a PEX connection 110 is shown with a crimp-indicating crimping ring 116, the differential structure of which will be described in greater detail below. Otherwise, apart from the crimping ring 116, the general structure, the connectivity of components, and the assembly of the PEX connection 110 in FIGS. 2A and 2B is the same as the conventional PEX connection 10 from FIG. 1. This means that the PEX tube 112 and the fitting 114 from the embodiment shown in FIGS. 2A and 2B may be substantially identical to their counterparts 12 and 14 from FIG. 1.

The assembly of the improved PEX connection 110 is generally similar to the assembly of the PEX connection 10 until the crimping operation. In FIGS. 2A and 2B, the fitting 114 is again received within the passageway of the PEX tube 112. The crimping ring 116 is slid around the PEX tube 112 and positioned radially outward from a portion of the fitting 114 and the PEX tube 112, such that a portion of the fitting 114 and the tube 112 are received within the crimping ring 116.

However, at the crimping step, the difference between the old PEX connection 10 and the new PEX connection 110 can be seen. Prior to being crimped, the crimping ring 116 has a first appearance, as shown by the “darker” shading in FIG. 2A. After being crimped and as illustrated in FIG. 2B, the crimping ring 116 is both reduced in size evenly about its circumference to form a leak-free, water tight seal between the PEX tube 112 and the fitting 114 and now additionally displays an indication that the crimping action has been completed by taking on a second appearance as shown by the “lighter” shading in FIG. 2B. This second appearance visually indicates to a user or other observer that a dimensional state of the crimping ring 116 has been changed.

Put another way, the pre- and post-crimping ring 116 have different, clearly visible appearances that are easily discernible from one another. In some embodiments, this visual indication can be viewable from 10 feet or more away from the crimping ring 116, and may save a contractor time by allowing the contractor to quickly determine whether or not the connection 100 has been crimped yet and, moreover, may avoid the prior necessity of confirming whether crimping has occurred with a gauge.

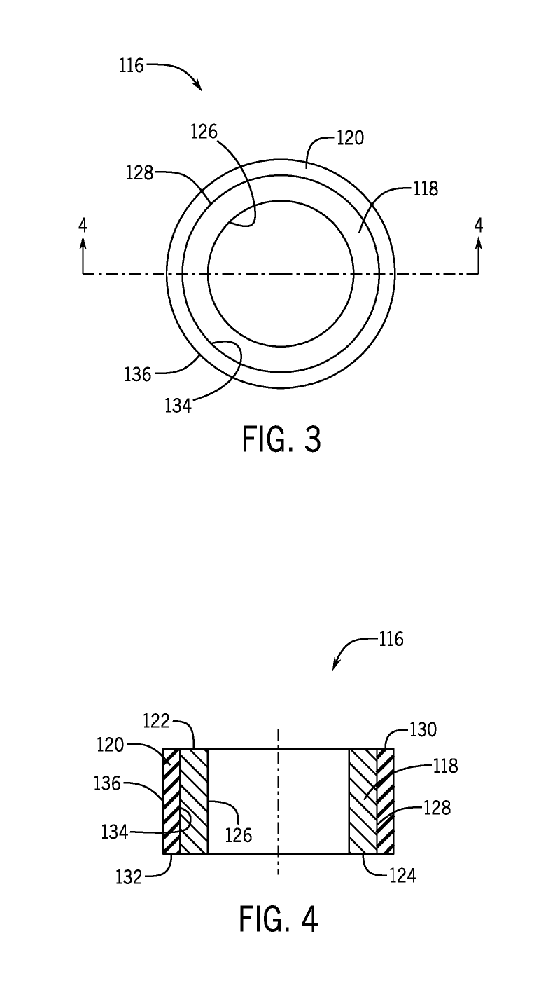

Turning now to FIGS. 3 and 4, the indicating crimping ring 116 is shown in isolation (i.e., apart from the rest of the PEX connection 110). The indicating crimping ring 116 includes a metallic ring 118 and an indicator 120 applied to at least a portion of the metallic ring 118.

The metallic ring 118 is a generally cylindrical body with an axial opening extending therethrough having a first axial end 122, a second axial end 124, a radially inward surface 126, and a radially outward surface 128.

The radially inward surface 126 may be sized to accommodate a number of different sizes of PEX tubing and could define an inner diameter between about 0.63 cm (0.25 in) to about 15.24 cm (6.0 in), or greater. Ideally, the radially inward surface 126 of the metallic ring 118 is sized to provide a small initial clearance between an outer surface of the corresponding PEX tubing 112 and the radially inward surface 126 of the metallic ring 118. This may allow for easy insertion of the crimping ring 116 over the PEX tubing 112 and will allow for easy locational adjustment of the crimping ring 116 relative to the PEX tubing 112 prior to crimping the crimping ring 116.

Similarly, the radially outward surface 128 of the metallic ring 118 may vary in size. In some embodiments, the radially outward surface 128 may be a constant distance from the radially inward surface 126 along the entire axial length from the first axial end 122 to the second axial end 124 of the metallic ring 118, which results in a tubular, cylindrical form for the crimping ring 116 with constant inner and outer diameters, respectively, and even radial thicknesses therebetween. In some embodiments, this constant thickness may be about 0.0635 cm (0.025 in) or about 0.381 cm (0.150) and could be anywhere within that range of distances.

It is contemplated that the metallic ring 118 may be formed of copper, stainless steel, aluminum, or other suitable metals for crimping.

The indicator 120 of the crimping ring 116 is applied to at least a portion of the radially outward surface 128 of the metallic ring 118. In some embodiments, the indicator 120 may be received around the entire radially outward surface 128. Similar to the metallic ring 118, the indicator 120 has a first axial end 130, a second axial end 132, a radially inward surface 134, and a radially outward surface 136. In some embodiments, the indicator 120 may have a constant cross-sectional area and a constant radial thickness, while in others, the distance between the radially inward surface 134 and radially outward surface 136 may vary. The radially inward surface 134 of the indicator 120 may be established by the dimensions of the radially outward surface 136 of the metallic ring 134.

The indicator 120 of the crimping ring 116 is designed to visually indicate a dimensional state of the crimping ring 116. Specifically, the indicator indicates whether a crimping ring 116 is in an uncrimped state (see FIG. 2A) or a crimped state (see FIG. 2B). In order to visually indicate this changed dimensional state, the indicator 120 may take a number of different forms.

The indication process may occur in a number of ways. For example, in some embodiments, the indicator 120 may change appearances to indicate that it is in a crimped state or an uncrimped state. This appearance change could comprise a change in colors. For example, indicator 120 may display a first color (e.g., white) when the crimping ring 116 is in a relaxed or uncrimped position. When a certain, predetermined threshold pressure is applied to the radially outward surface 128 of the metallic ring 118 (and, correspondingly, the indicator 120), the indicator 120 may change colors to a second color (e.g., to blue) to indicate that the crimping ring 116 has been crimped. In another embodiment, the colors could be chosen to more intuitively indicate which state the crimping ring 116 is in. For example, an uncrimped ring may display a red color to indicate that action is required. Once the crimping ring 116 is crimped, the indicator 120 may then display a green color to indicate that no further action is required.

In other embodiments, the indication process may occur by removing material during the crimping process. In some embodiments, the force applied by the crimping tool during crimping may be sufficient to fracture, break, or tear a portion of the indicator 120. In such embodiments, the portion of the indicator 120 that has been altered can be designed to visually indicate that it has been altered. For example, the color of the indicator 120 could be chosen such that it contrasts the color of the underlying metallic ring 118. When material is removed or altered, the underlying metallic ring 118 could become at least partially exposed. A showing of multiple colors could then indicate that the crimping ring 116 has been crimped. In some embodiments, the indicator 120 may be removed entirely when the crimping process occurs. The force from the crimping tool may cause the indicator 120 to crack and release from the radially outward surface 128 of the metallic ring 118. The visual appearance of the underlying metallic ring 118 would then indicate that the crimping process has occurred, and that no further action is required. Similarly, the indicator 120 might have a radially outward surface 136 that changes colors when a threshold frictional force or tension is applied, such as the frictional force or tension supplied by a crimping tool, which may scratch or non-destructively elongate the indicator surface. The indicator 120 may then display at least one additional color at locations where the frictional force or tension was applied, to indicate that the crimping ring 116 has been exposed to the crimping force previously.

Accordingly, the indicator 120 may comprise a variety of different materials, including polymers, paints, tapes, or other materials capable of indicating a changed dimensional state. In some embodiments, the indicator 120 comprises a plastic material that can change colors to indicate that a threshold pressure has been applied to the radially outward surface 128 of the metallic ring 118. For example, polyvinyl chloride film or damage indicating paint may be used to perform this type of indication. In some embodiments, the threshold pressure may be equivalent or approximately equivalent to or slightly less than the pressure applied to the radially outward surface 128 of the metallic ring 118 by the crimping tool when the crimping ring 116 is installed. Additionally, in some embodiments, the color change is a one-way, non-reversible reaction, where the color of the indicator 120 will not return to its resting color or original color once it has been crimped by the crimping tool.

In some embodiments, the indicator 120 may comprise paint. In such embodiments, the indication process can occur in a number of different ways, including the pressure indication described above with respect to polymeric indicators, as well as the frictional force or scratch indication methods provided earlier. For example, an indicator 120 comprised of paint could initially exhibit a white color when the ring is not in a crimped state. Then, when the crimping tool is applied, the paint could change to a color contrasting the initial color, such as a red or blue, to indicate that the crimping process has occurred. Additionally, paint may indicate that a crimping ring 116 has been crimped by releasing from the metallic ring 118 when pressure is applied by a crimping tool. In some embodiments, paint can become brittle when it is dried around the radially outward surface 128 of the metallic ring 118. When the crimping ring 116 is crimped, force will be applied to the radially outward surface 136 of the indicator 120, which may be great enough to cause the indicator 120 to crack. The cracking may cause the indicator 120 to release or separate (partially or fully) from the radially outward surface 128 of the metallic ring 118, thereby exposing at least a portion of the underlying metallic ring 118. When a user sees the metallic color, he or she can then immediately know that a ring has been previously crimped.

A number of different films or tapes may also be suitable for use in the present disclosure, as they are similarly capable of indicating that a crimping force has been applied to the crimping ring 116. In some embodiments, a thin film can be provided about a portion of the radially outward surface 128 of the metallic ring 118 in a color that contrasts the color of the metallic ring 118. When the ring 116 is crimped, the frictional force of the crimping tool used may cause the film to tear, exposing a larger portion of the metallic ring 118 for viewing by a user. Such suitable films or tapes may comprise of polyvinyl chloride or polyethylene.

Further, it should be appreciated that a combination of these materials can be used in a single indicator. For example, the indicator 120 may comprise an underlying polymeric layer and a film layer. In such embodiments, the polymeric layer and film layer may comprise different colors. When the crimping tool is used to crimp the crimping ring, the force provided by the tool may cause the film to tear and expose a portion of the underlying polymeric layer, which can indicate to a user that the ring has been crimped. To make the indication visible from further away, the underlying polymeric layer and film layers can be chosen with different colors. For example, an underlying polymeric layer could be white, while the film layer could be red. In such cases, the underlying polymeric layer would not need to be capable of changing colors or altering appearance as well, and could be made from high density polyethylene, polyvinylchloride, or other suitable materials. Similarly, the film could be made from a polymeric material or could be a paint, such as, for example, a specific paint base that allows the paint to change color.

As stated throughout, the indicator 120 can be chosen to have a variety of different colors. In some embodiments, the indicator comprises a different color than the metallic ring 118. For example, the indicator 120 may be white, while the metallic ring 118 may be a traditional copper color. In such examples, the presence of multiple colors may alert a user that a ring 116 has been crimped. In some embodiments, the indicator 120 can have a bright color, such as a neon green, blaze orange, or pink when it is in an uncrimped state. This may signal to a user that action is required on the fitting, and could also help avoid losing any parts during the installation process.

The indicator 120 may be applied to the metallic ring 118 in a variety of ways. In some embodiments, the radially inward surface 134 of the indicator 120 may be adhesively coupled to the radially outward surface 128 of the metallic ring 118. In other embodiments, the indicator 120 may be molded around a portion of the metallic ring 118. In still other embodiments, the indicator 120 may be brushed or sprayed onto the radially outward surface 128 of the metallic ring 118, in situations where the indicator may comprise a paint component. It should be appreciated that other methods of applying an indicator 120 to a metallic ring 118 are also suitable for use in creating crimping rings 116 and fall within the scope of the present disclosure.

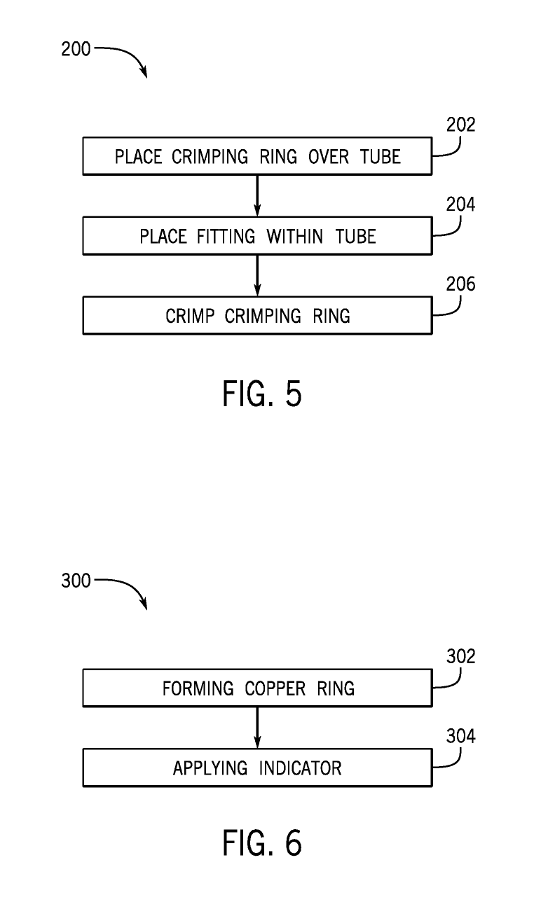

Turning now to FIG. 5, a method 200 of securing a fitting within a tube using an indicating crimp ring is disclosed. At step 202, the process may begin by placing a crimping ring, such as crimping ring 116 described with reference to FIGS. 2A, 2B, 3, and 4 above, over an outer surface of a tube 112. The crimping ring 116 has a metallic ring 118 having a radially inward surface 126 and a radially outward surface 128, as well an indicator 120 applied to at least a portion of the radially outward surface 128 of the metallic ring 118. The indicator 120 is configured to communicate a dimensional state of the crimping ring 116.

At step 204, a fitting 114 may be placed within a portion of an inner surface of the tube 112. The fitting 114 can be chosen with a size and design such that only a portion of the fitting 114 can extend into the inner surface of the tube 112. For example, a portion of the tubing 112 can be sized to provide a stop edge having a larger diameter than the inner surface of the tube 112. This can allow for easy positioning within the tube 112. The fitting 114 may comprise copper or other suitable fitting materials for use in a PEX system. It should be appreciated that in some embodiments of the present method, step 204 can be performed prior to performing step 202, provided that the radially inward surface 126 of the crimping ring 116 (in an uncrimped state) has a diameter greater than the largest diameter of the fitting 114.

At step 206, the crimping ring 116 can be crimped to form a seal between the fitting 114 and the inner surface of the tube 112. The process of crimping the crimping ring 116 causes the indicator 120 to be altered. For example, the crimping process may cause the color of the indicator 120 to change. To perform this process, the indicator 120 could comprise a color-changing plastic, a color-changing paint, a color-changing film, a combination of these, or other suitable color-changing materials. In some embodiments, the indicator 120 may be altered by removing a portion of the indicator 120. For example, an indicator 120 comprising paint could crack during the crimping process, causing some of the paint to release from the metallic ring 118. Similarly, an indicator 120 comprising a film could tear, causing part of the indicator 120 to be removed as well. The crimping process may be performed by a crimping tool, which can compress a crimping ring 116 about the entire circumference of the ring 116 to form the seal.

Turning now to FIG. 6, a method 300 for manufacturing a crimping ring, such as the crimping ring 116 described with reference to FIGS. 2A, 2B, 3, and 4, is disclosed. The method 300 comprises forming a metallic ring according to step 302. The metallic ring can comprise copper, stainless steel, or other materials. The metallic ring has a radially inward surface and a radially outward surface.

The method 300 additionally comprises applying an indicator to a portion of the radially outward surface of the copper ring according to step 304. The indicator visually indicates a dimensional state of the crimping ring 116. Dimensional states of the crimping ring 116 may be one of crimped or uncrimped, for example. The indicator 120 may comprise a number of materials, such as polymers, paint, a combination of these materials, or other materials suitable for indicating a dimensional state change when exposed to a threshold pressure.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A crimping ring for securing a fitting within a tube, the crimping ring comprising:
a metallic ring having a radially inward surface and a radially outward surface; and
an indicator applied to at least a portion of the radially outward surface of the metallic ring, wherein the indicator visually indicates a dimensional state of the crimping ring.

2. The crimping ring of claim 1, wherein the dimensional state of the crimping ring is one of crimped or not crimped.

3. The crimping ring of claim 1, wherein the metallic ring and the indicator comprise different colors.

4. The crimping ring of claim 1, wherein the indicator changes colors to indicate a changed state of the crimping ring when a threshold pressure has been applied to the radially outward surface of the metallic ring.

5. The crimping ring of claim 1, wherein at least a portion of the indicator releases from the radially outward surface of the metallic ring when a threshold pressure has been applied to the radially outward surface of the metallic ring to indicate a changed state of the crimping ring.

6. The crimping ring of claim 1, wherein the indicator is paint.

7. The crimping ring of claim 1, wherein the indicator is a film adhesively applied to the radially outward surface of the metallic ring.

8. A method of securing a fitting within a tube, the method comprising:
placing a crimping ring over a portion of an outer surface of a tube, the crimping ring comprising a metallic ring and an indicator, the metallic ring having a radially inward surface and a radially outward surface, and the indicator being applied to at least a portion of the radially outward surface and configured to indicate a dimensional state of the crimping ring;
placing a fitting within a portion of an inner surface of the tube; and
crimping the crimping ring to form a seal between the fitting and the inner surface of the tube, wherein the step of crimping the crimping ring causes the indicator to be altered.

9. The method of claim 8, wherein a color of the indicator is altered when the crimping ring is crimped.

10. The method of claim 9, wherein the indicator comprises a color-changing plastic.

11. The method of claim 9, wherein the indicator comprises a color-changing paint.

12. The method of claim 9, wherein the indicator comprises a color-changing film.

13. The method of claim 8, wherein the altering of the indicator includes removing a portion of the indicator from the crimping ring.

14. The method of claim 13, wherein the portion of the indicator removed comprises paint.

15. The method of claim 13, wherein the portion of the indicator removed comprises film.

16. The method of claim 8, wherein the step of crimping the crimping ring is performed by a crimping tool.

17. A method for manufacturing a crimping ring, the method comprising:
forming a metallic ring, the metallic ring having a radially inward surface and a radially outward surface; and
applying an indicator to a portion of the radially outward surface of the metallic ring, wherein the indicator visually indicates a dimensional state of the crimping ring.

18. The method of claim 17, wherein the dimensional state of the crimping ring is one of crimped or not crimped.

19. The method of claim 17, wherein the indicator comprises a polymeric material.

20. The method of claim 17, wherein the indicator comprises a paint.
